(19) United States
(12) Patent Application Publication
(10) Pub. No.: US 2026/0031571 A1
(43) Pub. Date: Jan. 29, 2026

(54) FLOATING CONNECTOR

(71) Applicant: P-TWO INDUSTRIES INC., Taoyuan City (TW)

(72) Inventors: Hsien-Chang Lin, Taoyuan City (TW); Chih-Wei Huang, Taoyuan City (TW)

(21) Appl. No.: 19/235,905

(22) Filed: Jun. 12, 2025

(30) Foreign Application Priority Data
Jul. 23, 2024 (TW) 113127567

(51) Int. Cl. H01R 13/631; H01R 12/70; H01R 13/187; H01R 13/502; H01R 13/6588

(52) U.S. Cl. CPC H01R 13/6315; H01R 12/707; H01R 12/7082; H01R 13/187; H01R 13/502; H01R 13/6588

(57) ABSTRACT

The present invention provides a floating connector, which includes a first housing, a second housing, a plurality of contact members and a high-frequency insulating member. The second housing is assembled to the first housing in a manner that is movable on a plane perpendicular to a first direction. Each contact member includes: a fixed portion, a first holding portion, a spring portion, a second holding portion and a contact portion. The first holding portion is held by the first housing, and the second holding portion is held by the second housing. The high-frequency insulating member is assembled on a bottom of the second housing along the first direction. The high-frequency insulating member includes a plurality of accommodating grooves, and the accommodating grooves are arranged at predetermined intervals in the second direction to accommodate the contact members. Each accommodation groove accommodates a local structure of the spring portion of the corresponding contact member adjacent to the second holding portion.

### CROSS-REFERENCES TO RELATED APPLICATIONS

This application claims the benefit of priority to Taiwanese Patent Application No. 113127567 filed on Jul. 23, 2024, which is hereby incorporated by reference in its entirety.

### BACKGROUND OF THE INVENTION

### Field of the Invention

The present invention relates to a floating connector, and in particular to a floating connector that stabilizes high-frequency signal transmission.

### Descriptions of the Related Art

It is known that in the design of floating connectors, most of the terminals located in the floating area of the connector housing are in a suspended state without contact with the housing. When the floating connector is used for transmitting high-frequency signals, this can easily cause transmission oscillation in the entire transmission segment between the two circuit boards, significantly reducing the stability of high-frequency signal transmission. To address this issue, floating connectors typically increase the width of the terminals in the transmission segment, thereby enlarging the cross-sectional area of the terminals to modify the likelihood of transmission oscillation. However, considering that the terminals must be assembled and fixed with the connector housing, the width of the portion where the terminals are assembled with the floating housing must be reduced. This, in turn, increases the capacitance in that section, leading to unstable signal transmission. This presents a significant problem for high-frequency signal transmission.

### SUMMARY OF THE INVENTION

The objective of the present invention is to provide a floating connector that enables stable high-frequency signal transmission.

According to an embodiment of the present invention, a floating connector is provided, comprising a first housing, a second housing, a plurality of contact members, and a high-frequency insulating member. The second housing includes a fitting portion that engages with a mating connector in a first direction and a bottom opposite the fitting portion. The second housing is assembled to the first housing in a manner that is movable on a plane perpendicular to the first direction. The contact members are made of conductive material and are arranged at predetermined intervals in a second direction perpendicular to the first direction. Each of the contact members comprises a fixed portion, a first holding portion, a spring portion, a second holding portion, and a contact portion. The first holding portion is held by the first housing. The second holding portion is held by the second housing. The first holding portion extends from the fixed portion. The spring portion connects the first holding portion and the second holding portion. The contact portion extends from the second holding portion. The high-frequency insulating member is assembled on the bottom of the second housing along the first direction. The high-frequency insulating member includes a plurality of accommodating grooves. The accommodating grooves are arranged at predetermined intervals in the second direction to accommodate the contact members. Each of the accommodating grooves accommodates a local structure of the corresponding contact member, and the local structure is located at the spring portion adjacent to the second holding portion.

The floating connector of the present invention, wherein the second housing comprises a plurality of fixing members, and the fixing members are disposed on the bottom to secure the high-frequency insulating member.

The floating connector of the present invention, wherein the high-frequency insulating member further comprises two long sides, two short sides, a top surface, and an opposite bottom surface. Each of the accommodating grooves penetrates from the top surface to the bottom surface in the first direction, and each of the accommodating grooves extends toward a surface of the long side in a third direction perpendicular to the first direction and the second direction, forming an opening for the local structure to pass.

The floating connector of the present invention, wherein the high-frequency insulating member further comprises a plurality of chamfer portions, and the chamfer portions are located at junctions of the long sides and the short sides.

The floating connector of the present invention, wherein each of the accommodating grooves comprises an accommodating groove chamfer, and the groove chamfer is positioned in the accommodating groove and near the top surface.

The floating connector of the present invention, wherein a width of each accommodating groove in the second direction is greater than a width of the local structure of the corresponding contact member in the second direction.

The floating connector of the present invention, wherein the second housing comprises a plurality of guiding members, the guiding members are disposed on the bottom, the high-frequency insulating member further comprises a plurality of guide grooves, and the guide grooves are disposed on the short sides.

The floating connector of the present invention, wherein the second housing comprises a plurality of positioning members, the positioning members are disposed on the bottom, the high-frequency insulating member further comprises a plurality of positioning grooves, and each of the positioning grooves penetrating from the top surface to the bottom surface along the first direction.

The floating connector of the present invention, wherein the second housing further comprises a plurality of through holes, and each of the through holes penetrates from the fitting portion to the bottom in the first direction.

The floating connector of the present invention, wherein the spring portion comprises a first curved portion, a second curved portion, an extension portion, a third curved portion, and a fourth curved portion. The first holding portion is connected to one end of the extension portion through the first curved portion and the second curved portion. The second holding portion is connected to the other end of the extension portion through the third curved portion and the fourth curved portion. The local structure is located between the second holding portion and the third curved portion, encompassing the fourth curved portion.

After referring to the drawings and the embodiments as described in the following, those the ordinary skilled in this art can understand other objectives of the present invention, as well as the technical means and embodiments of the present invention.

### BRIEF DESCRIPTION OF THE DRAWINGS

FIG. 1 is a perspective view of the floating connector according to the present invention;

FIG. 2 is an exploded perspective view of the floating connector according to the present invention;

FIG. 3 is a perspective view of the second housing;

FIG. 4 is a top view of the second housing;

FIG. 5 is a front view of the second housing;

FIG. 6 is a bottom view of the second housing;

FIG. 7 is a perspective view of the high-frequency insulating member;

FIG. 8 is a top view of the high-frequency insulating member;

FIG. 9 is a front view of the high-frequency insulating member;

FIG. 10 is a bottom view of the high-frequency insulating member;

FIG. 11 is a perspective view of the contact member;

FIG. 12 is a perspective view showing the high-frequency insulating member accommodating a plurality of contact members;

FIG. 13 is a front view showing the high-frequency insulating member accommodating a plurality of contact members;

FIG. 14 is a side view showing the high-frequency insulating member accommodating a plurality of contact members;

FIG. 15 is a sectional side view of the floating connector according to the present invention along the second direction;

FIG. 16 is another sectional side view of the floating connector according to the present invention along the second direction; and

FIG. 17 is a sectional side view of the floating connector according to the present invention along the third direction.

### DETAILED DESCRIPTION OF THE PREFERRED EMBODIMENT

The following describes the connector assembly of the embodiment of the present invention with reference to the accompanying drawings. In the various figures, identical components or components with the same functions are designated by the same reference symbols. The figures are not drawn to scale. It should be noted that, unless otherwise specified, the term “contact member” generally refers to a signal contact member.

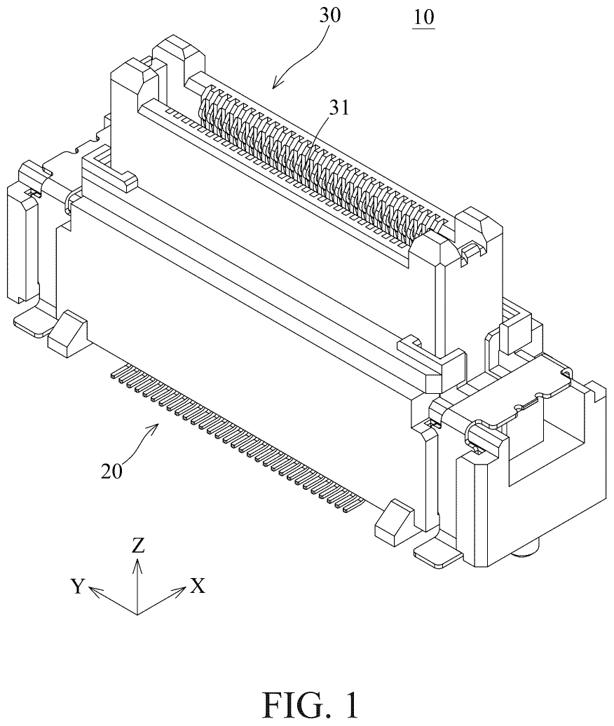

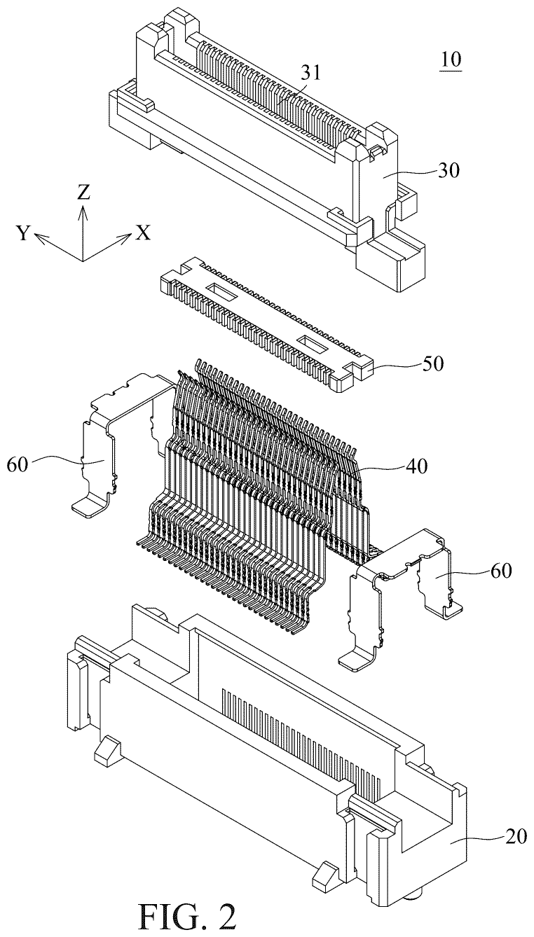

With reference to FIGS. 1 and 2, the components of the floating connector 10 of the present invention are summarized. FIG. 1 is a perspective view of the floating connector according to the present invention. FIG. 2 is an exploded perspective view of the floating connector 10 according to the present invention. The floating connector is designated by the reference symbol 10. The floating connector 10 is mounted on a printed circuit board (not shown) and is electrically connected to a mating connector (not shown) located on another printed circuit board. The floating connector 10 is specifically implemented as a socket connector, while the mating connector is specifically implemented as a plug connector.

The floating connector 10 includes a first housing 20 as a fixed housing, a second housing 30 as a movable housing, a plurality of contact members 40, a resin high-frequency insulating member 50, and two grounding components 60.

The second housing 30 has a fitting portion 31 that engages with the mating connector in the first direction. The second housing 30 is assembled to the first housing 20 in a manner that allows movement in a plane perpendicular to the first direction. In the present invention, the first direction is defined as the Z-axis direction, the second direction is defined as the Y-axis direction, and the third direction is defined as the X-axis direction, while the plane perpendicular to the first direction is defined as the XY plane.

In this embodiment, the number of the plurality of contact members 40 is 60, arranged in pairs with 30 contact members 40 in each group. The floating connector 10 may also include a plurality of power contact members (not shown), positioned on either side of each group of contact members 40. The contact members 40 and the power contact members are made of conductive materials, such as copper or copper alloys. However, the present invention is not limited to this, and the number of contact members 40 or power contact members can be increased or decreased as needed.

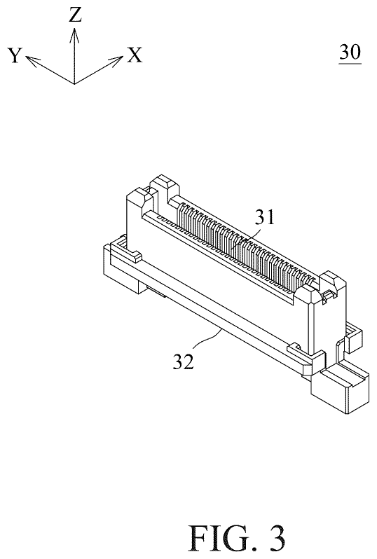

Referencing FIGS. 3 to 6, further details of the second housing 30 will be explained.

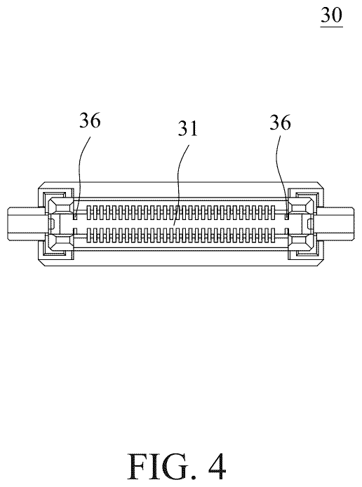

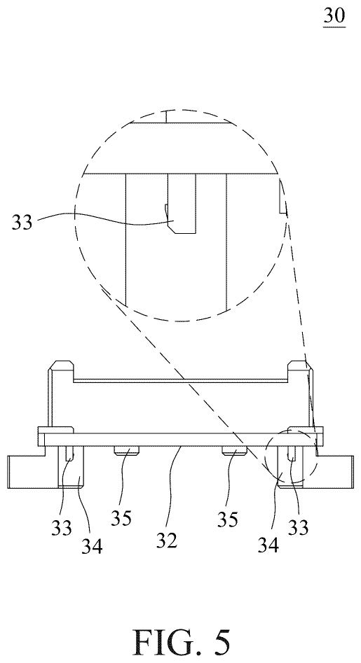

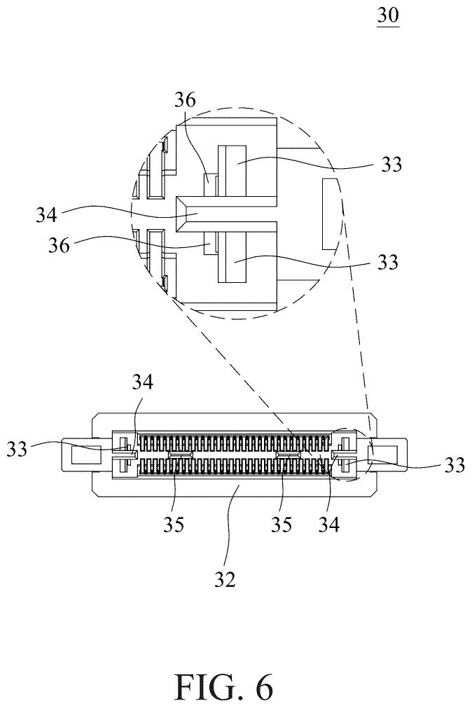

FIG. 3 is a perspective view of the second housing 30. FIG. 4 is a top view of the second housing 30. FIG. 5 is a front view of the second housing 30. FIG. 6 is a bottom view of the second housing 30. The second housing 30 has a bottom 32, which is positioned opposite to the fitting portion 31, and the bottom 32 is primarily located on a plane perpendicular to the first direction, allowing for the assembly of the high-frequency insulating member 50 along the first direction. The second housing 30 includes a plurality of fixing members 33, which are protruded from the bottom 32 to securely hold the high-frequency insulating member 50. These fixing members 33 are located at both ends of the bottom 32, with each fixing member 33 having a hook structure with elastic arms. In this embodiment, the number of fixing members 33 is two, arranged in pairs. However, the invention is not limited to this, and the number of fixing members 33 can be increased or decreased as needed. After the high-frequency insulating member 50 is assembled onto the bottom 32 of the second housing 30, these fixing members 33 can prevent the high-frequency insulating member 50 from longitudinally (in the first direction) displacing relative to the second housing 30.

The second housing 30 further includes a plurality of guiding members 34, which are protruded from the bottom 32 to guide the assembly position of the high-frequency insulating member 50. These guiding members 34 are located at both ends of the bottom 32, with each guiding member 34 having a slider structure. In this embodiment, the number of guiding members 34 is two, arranged in pairs. However, the invention is not limited to this, and the number of guiding members 34 can be increased or decreased as needed. During the assembly process of the high-frequency insulating member 50 onto the second housing 30, these guiding members 34 act as guiding means. After the high-frequency insulating member 50 is assembled onto the second housing 30, these guiding members 34 can prevent the high-frequency insulating member 50 from laterally (in the plane perpendicular to the first direction) displacing relative to the second housing 30. Each guiding member 34 has a guiding member chamfer, located at the end of the guiding member 34 away from the bottom 32. During the assembly process of the high-frequency insulating member 50 onto the second housing 30, the guiding member chamfer serves to reduce structural interference between the guiding member 34 and the high-frequency insulating member 50.

The second housing 30 further includes a plurality of positioning members 35, which are protruded from the bottom 32 to position the assembly location of the high-frequency insulating member 50. These positioning members 35 are located between the fixed members 33, with each positioning member 35 having a protruding pillar structure. In this embodiment, the number of positioning members 35 is two, arranged in pairs. However, the invention is not limited to this, and the number of positioning members 35 can be increased or decreased as needed. During the assembly process of the high-frequency insulating member 50 onto the second housing 30, these positioning members 35 serve as positioning means. After the high-frequency insulating member 50 is assembled onto the second housing 30, these positioning members 35 can prevent the high-frequency insulating member 50 from laterally (in the plane perpendicular to the first direction) displacing relative to the second housing 30. Each positioning member 35 has a positioning member chamfer, located at the end of the positioning member 35 away from the bottom 32. During the assembly process of the high-frequency insulating member 50 onto the second housing 30, the positioning member chamfer acts to reduce structural interference between the positioning member 35 and the high-frequency insulating member 50.

The second housing 30 further includes a plurality of through holes 36. Each through hole 36 penetrates from the fitting portion 31 to the bottom 32 in the first direction. In this embodiment, there are four through holes 36, arranged in pairs. However, the invention is not limited to this, and the number of through holes 36 can be increased or decreased as needed. After the high-frequency insulating member 50 is assembled onto the second housing 30, these through holes 36 serve as means for disassembling the high-frequency insulating member 50, allowing tools to pass through the through holes 36 in the first direction to disassemble the assembled high-frequency insulating member 50.

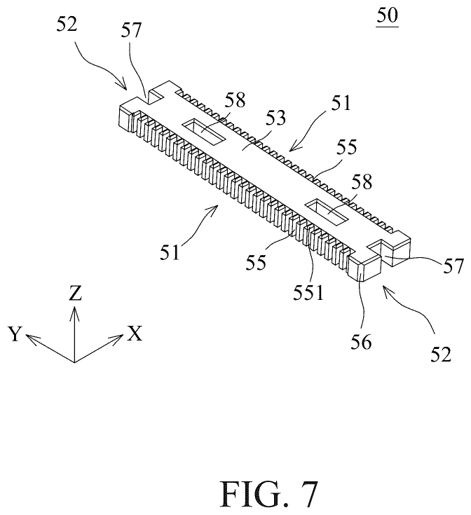

Refer to FIGS. 7 to 10 for further explanation of the high-frequency insulating member 50.

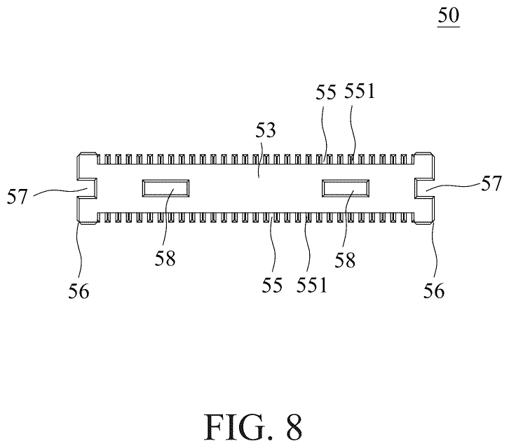

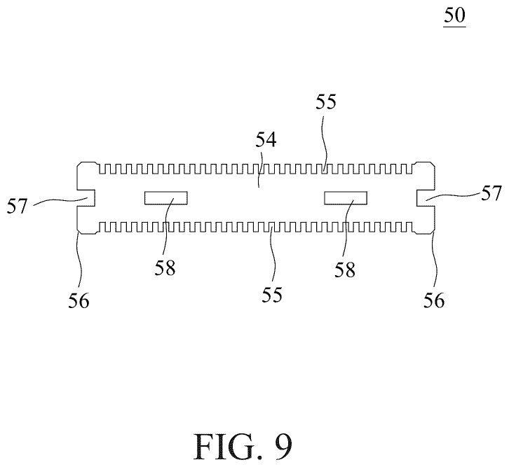

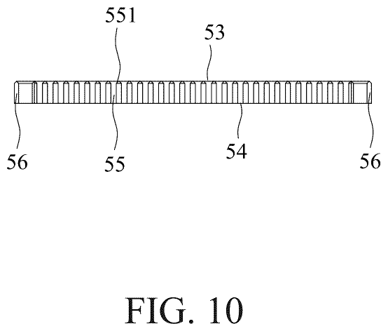

FIG. 7 is a perspective view of the high-frequency insulating member 50. FIG. 8 is a top view of the high-frequency insulating member 50. FIG. 9 is a front view of the high-frequency insulating member 50. FIG. 10 is a bottom view of the high-frequency insulating member 50. The high-frequency insulating member 50 is assembled along the first direction onto the bottom 32 of the second housing 30. The high-frequency insulating member 50 includes two long sides 51, two short sides 52, a top surface 53, an opposite bottom surface 54, and a plurality of accommodating grooves 55. The long sides 51 and short sides 52 are interposed between the top surface 53 and bottom surface 54, with each end of the long sides 51 connected to a different short side 52. Both the top surface 53 and the bottom surface 54 are planes perpendicular to the first direction, and the top surface 53 can be fitted to the bottom 32 of the second housing 30 along the first direction. Each long side 51 extends in the second direction and is perpendicular to the top surface 53 and the bottom surface 54, while each short side 52 extends in the third direction and is perpendicular to the top surface 53 and the bottom surface 54. The high-frequency insulating member 50 further includes a plurality of chamfer portions 56, which are located at the junctions of the long sides 51 and the short sides 52. During the assembly of the high-frequency insulating member 50 to the second housing 30, these chamfer portions 56 can serve to reduce structural interference between the second housing 30 and the high-frequency insulating member 50.

The accommodating grooves 55 are arranged on the long sides 51, at predetermined intervals in the second direction. The quantity, position, and structural type of these accommodating grooves 55 correspond to the quantity, position, and structural type of the contact members 40 to accommodate them. In this embodiment, the number of accommodating grooves 55 is 60, arranged in pairs of 30 accommodating grooves 55 each. However, the invention is not limited to this; the number of accommodating grooves 55 can be adjusted based on the quantity of the contact members 40. Each accommodating groove 55 extends from the top surface 53 to the bottom surface 54 in the first direction, and each accommodating groove 55 extends toward the surface of the long side 51 in the third direction, forming an opening to allow the corresponding contact member 40 to pass through and be accommodated in the accommodating groove 55. Each accommodating groove 55 has an accommodating groove chamfer 551, which is positioned in the accommodating groove 55 and near the top surface 53. During the assembly of the high-frequency insulating member 50 to the second housing 30, the accommodating groove chamfer 551 can serve to reduce structural interference between the contact members 40 and the high-frequency insulating member 50.

The high-frequency insulating member 50 also includes a plurality of guiding grooves 57, which are disposed on the short sides 52, with the quantity, position, and structural type of these guiding grooves 57 corresponding to the quantity, position, and structural type of the guiding members 34 of the second housing 30. Each guiding groove 57 has a sliding slot structure. In this embodiment, the number of guiding grooves 57 is 2, arranged in pairs. Each guiding groove 57 extends from the top surface 53 to the bottom surface 54 in the first direction, and each guiding groove 57 extends toward the surface of the short side 52 in the second direction, forming an opening to allow the guiding members 34 to pass through. During the assembly of the high-frequency insulating member 50 to the second housing 30, these guiding grooves 57, in conjunction with the guiding members 34, serve as guiding means. After the assembly of the high-frequency insulating member 50 to the second housing 30, these guiding grooves 57, together with the guiding members 34, can prevent the high-frequency insulating member 50 from displacing laterally (in the plane perpendicular to the first direction) relative to the second housing 30. Each guiding groove 57 has a guiding groove chamfer, which is positioned in the guiding groove 57 and near the top surface 53. During the assembly process of the high-frequency insulating member 50 to the second housing 30, the guiding groove chamfer can serve to reduce structural interference between the second housing 30 and the high-frequency insulating member 50.

The high-frequency insulating member 50 also includes a plurality of positioning grooves 58, which are arranged within the ranges of the long sides 51 and the short sides 52, with the quantity, position, and structural type of these positioning grooves 58 corresponding to the quantity, position, and structural type of the positioning members 35 of the second housing 30. In this embodiment, the number of positioning grooves 58 is 2, arranged in pairs. Each positioning groove 58 has a recessed structure, and each positioning groove 58 extends from the top surface 53 to the bottom surface 54 in the first direction. During the assembly of the high-frequency insulating member 50 to the second housing 30, these positioning grooves 58, in conjunction with the positioning members 35, serve as positioning means. After the assembly of the high-frequency insulating member 50 to the second housing 30, these positioning grooves 58, together with the positioning members 35, can prevent the high-frequency insulating member 50 from displacing laterally (in the plane perpendicular to the first direction) relative to the second housing 30. Each positioning groove 58 has a positioning groove chamfer, which is positioned in the positioning groove 58 and near the top surface 53. During the assembly process of the high-frequency insulating member 50 to the second housing 30, the positioning groove chamfer can serve to reduce structural interference between the second housing 30 and the high-frequency insulating member 50.

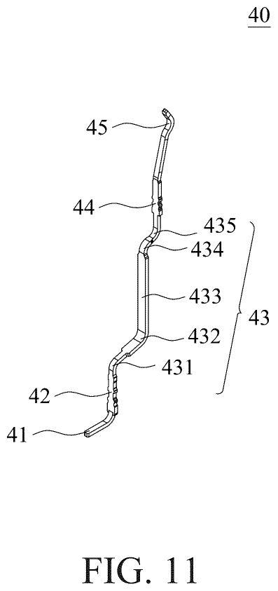

FIG. 11 is a perspective view of one of the contact member 40. The contact member 40 includes: a fixed portion 41, a first holding portion 42, a spring portion 43, a second holding portion 44, and a contact portion 45. The first holding portion 42 extends from the fixed portion 41, the spring portion 43 connects the first holding portion 42 and the second holding portion 44, and the contact portion 45 extends from the second holding portion 44. The fixed portion 41 is fixed to the printed circuit board by soldering.

The spring portion 43 includes a first curved portion 431, a second curved portion 432, an extending portion 433, a third curved portion 434, and a fourth curved portion 435. The first holding portion 42 is connected to one end of the extending portion 433 through the first curved portion 431 and the second curved portion 432, while the second holding portion 44 is connected to the other end of the extending portion 433 through the third curved portion 434 and the fourth curved portion 435. The bending direction of the first curved portion 431 is different from the bending direction of the second curved portion 432. Similarly, the bending direction of the third curved portion 434 is different from the bending direction of the fourth curved portion 435.

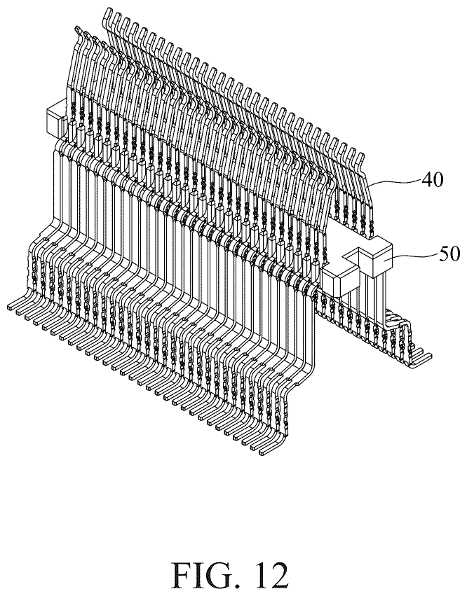

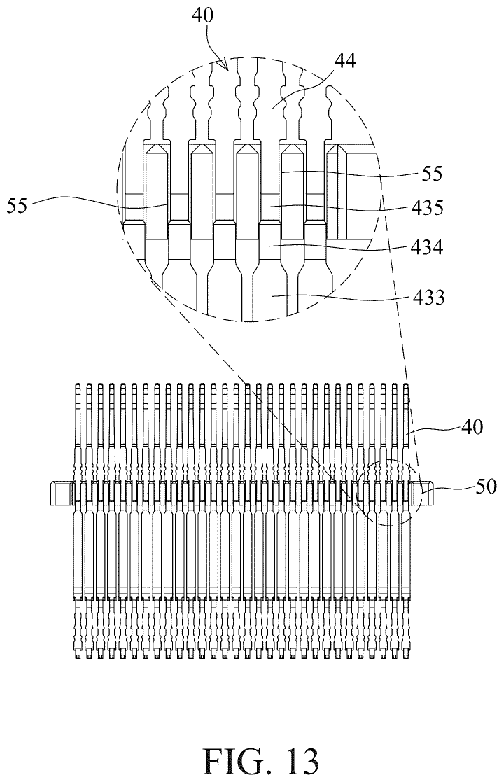

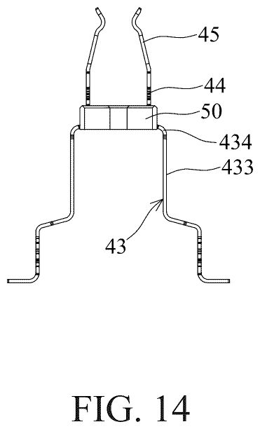

Referring to FIGS. 12 to 14. FIG. 12 is a perspective view showing the high-frequency insulating member 50 after accommodating the plurality of contact members 40. FIG. 13 is a front view showing the high-frequency insulating member 50 after accommodating the plurality of contact members 40. FIG. 14 is a side view showing the high-frequency insulating member 50 after accommodating the plurality of contact members 40. Since the plurality of contact members 40 are arranged at predetermined intervals in the second direction, and the accommodating grooves 55 of the high-frequency insulating member 50 are also arranged at predetermined intervals in the second direction, the accommodating grooves 55 can accommodate the contact members 40.

Each accommodating groove 55 accommodates a portion of the corresponding contact member 40, particularly the local structure of the spring portion 43 of the contact member 40. The local structure of the spring portion 43 of the contact member 40, which is accommodated in the accommodating groove 55 of the high-frequency insulating member 50, is located between the second holding portion 44 and the third curved portion 434, and the local structure encompasses the entire fourth curved portion 435. The local structure is adjacent to the second holding portion 44. To facilitate the accommodation of the contact members 40 in the accommodating groove 55 of the high-frequency insulating member 50, the structural design ensures that the width of each accommodating groove 55 in the second direction is greater than the width of the local structure of the contact members 40 in the second direction.

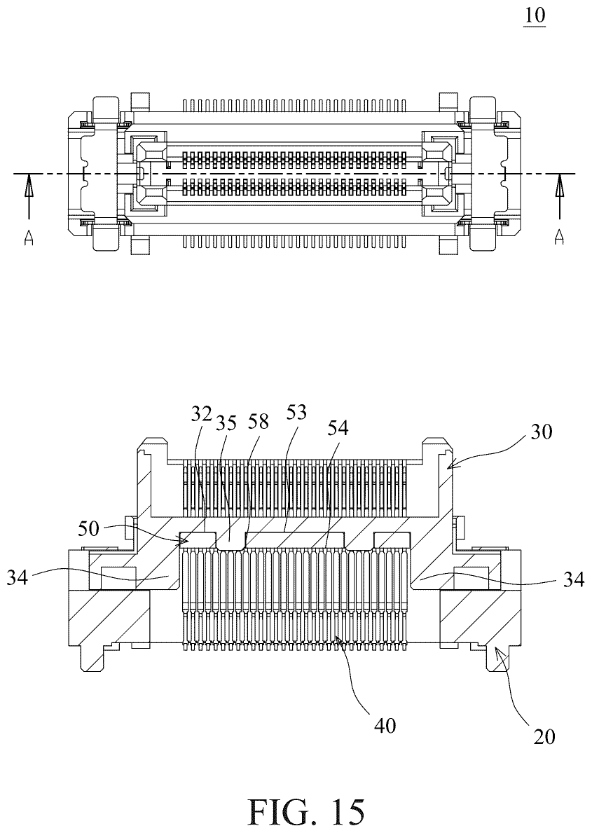

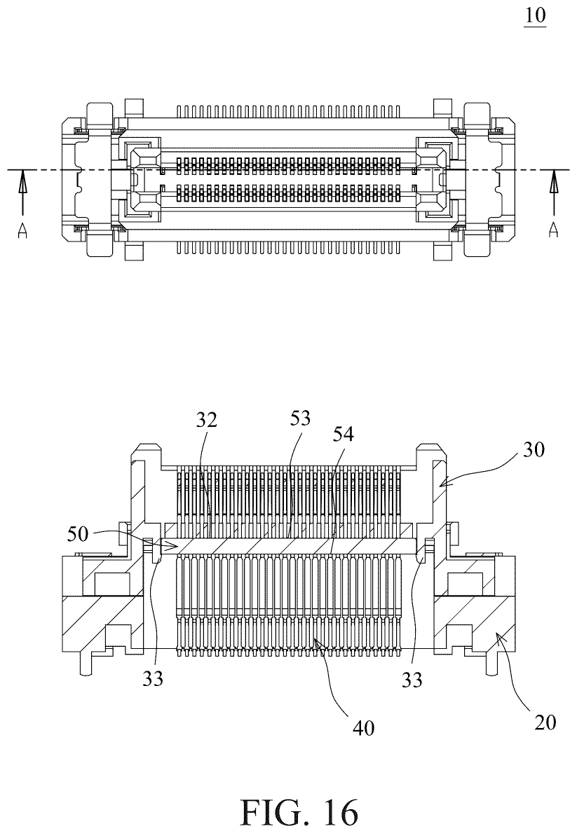

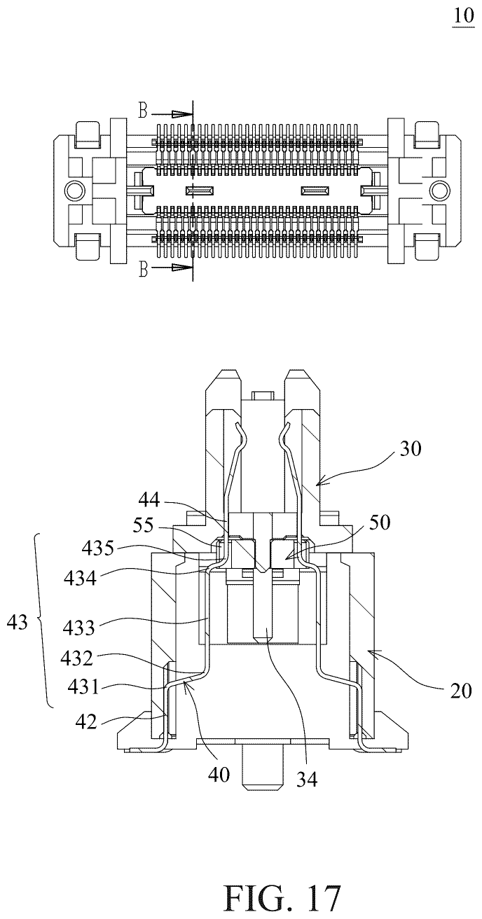

Referencing FIGS. 15 to 17, FIG. 15 is a sectional side view of the floating connector 10 according to the present invention along the second direction. FIG. 16 is another sectional side view of the floating connector 10 along the second direction. FIG. 17 is a sectional side view of the floating connector 10 along the third direction. During the assembly of the high-frequency insulating member 50 along the first direction to the second housing 30, the guiding members 34 of the second housing 30 gradually slide into the guiding grooves 57 of the high-frequency insulating member 50, ensuring that the high-frequency insulating member 50 is guided and held in place while being assembled along the first direction to the second housing 30. At the same time, the positioning members 35 of the second housing 30 gradually engage in the positioning grooves 58 of the high-frequency insulating member 50, thereby positioning the high-frequency insulating member 50 relative to the second housing 30 to maintain the correct assembly position. After the high-frequency insulating member 50 is assembled to the bottom 32 of the second housing 30 along the first direction, the fixing members 33 of the second housing 30 can secure the bottom surface 54 of the high-frequency insulating member 50 to fix the high-frequency insulating member 50 relative to the second housing 30. At this point, the high-frequency insulating member 50 is substantially held between the first housing 20 and the second housing 30.

The contact members 40 are assembled within the first housing 20 and the second housing 30. In terms of structural design, the first holding portion 42 of the contact member 40 is pressed and assembled into the first housing 20, where it is retained by the first housing 20, while the second holding portion 44 of the contact member 40 is pressed and assembled into the second housing 30, where it is retained by the second housing 30. Generally, the spring portion 43 of each contact member 40 is almost in a suspended state within the first housing 20. In this embodiment, during the assembly of the high-frequency insulating member 50 along the first direction to the second housing 30, the spring portion 43 of each contact member 40 near the local structure of the second holding portion 44 gradually enters and is accommodated in the corresponding accommodating groove 55 of the high-frequency insulating member 50. After the high-frequency insulating member 50 is assembled along the first direction to the second housing 30, the local structure of the spring portion 43 of each contact member 40 is completely accommodated within the respective accommodating groove 55, and the local structure is generally not in contact with the walls of the accommodating groove 55. Other portions of the spring portion 43, aside from this local structure, remain in a suspended state, thus not affecting the floating function of the connector. Therefore, the arrangement of the high-frequency insulating member 50 can reduce transmission oscillations during high-frequency signal transmission, enhancing the stability of high-frequency signal transmission.

The above embodiments are used only to illustrate the implementations of the present invention and to explain the technical features of the present invention, and are not used to limit the scope of the present invention. Any modifications or equivalent arrangements that can be easily accomplished by people skilled in the art are considered to fall within the scope of the present invention, and the scope of the present invention should be limited by the claims of the patent application.

1. A floating connector, comprising a first housing, a second housing, a plurality of contact members, and a high-frequency insulating member, wherein the second housing includes a fitting portion that engages with a mating connector in a first direction and a bottom opposite the fitting portion, the second housing is assembled to the first housing in a manner that is movable on a plane perpendicular to the first direction,
the contact members are made of conductive material and are arranged at predetermined intervals in a second direction perpendicular to the first direction, each of the contact members comprises a fixed portion, a first holding portion, a spring portion, a second holding portion, and a contact portion,
the first holding portion is held by the first housing, the second holding portion is held by the second housing, the first holding portion extends from the fixed portion, the spring portion connects the first holding portion and the second holding portion, the contact portion extends from the second holding portion,
the high-frequency insulating member is assembled on the bottom of the second housing along the first direction, the high-frequency insulating member includes a plurality of accommodating grooves, the accommodating grooves are arranged at predetermined intervals in the second direction to accommodate the contact members, each of the accommodating grooves accommodates a local structure of the corresponding contact member, and the local structure is located at the spring portion adjacent to the second holding portion.

2. The floating connector of claim 1, wherein the second housing comprises a plurality of fixing members, and the fixing members are disposed on the bottom to secure the high-frequency insulating member.

3. The floating connector of claim 1, wherein the high-frequency insulating member further comprises two long sides, two short sides, a top surface, and an opposite bottom surface, each of the accommodating grooves penetrates from the top surface to the bottom surface in the first direction, and each of the accommodating grooves extends toward a surface of the long side in a third direction perpendicular to the first direction and the second direction, forming an opening for the local structure to pass.

4. The floating connector of claim 3, wherein the high-frequency insulating member further comprises a plurality of chamfer portions, and the chamfer portions are located at junctions of the long sides and the short sides.

5. The floating connector of claim 3, wherein each of the accommodating grooves comprises an accommodating groove chamfer, and the groove chamfer is positioned in the accommodating groove and near the top surface.

6. The floating connector of claim 3, wherein a width of each accommodating groove in the second direction is greater than a width of the local structure of the corresponding contact member in the second direction.

7. The floating connector of claim 3, wherein the second housing comprises a plurality of guiding members, the guiding members are disposed on the bottom, the high-frequency insulating member further comprises a plurality of guide grooves, and the guide grooves are disposed on the short sides.

8. The floating connector of claim 3, wherein the second housing comprises a plurality of positioning members, the positioning members are disposed on the bottom, the high-frequency insulating member further comprises a plurality of positioning grooves, and each of the positioning grooves penetrates from the top surface to the bottom surface along the first direction.

9. The floating connector of claim 1, wherein the second housing further comprises a plurality of through holes, and each of the through holes penetrates from the fitting portion to the bottom in the first direction.

10. The floating connector of claim 9, wherein the spring portion comprises a first curved portion, a second curved portion, an extension portion, a third curved portion, and a fourth curved portion, the first holding portion is connected to one end of the extension portion through the first curved portion and the second curved portion, the second holding portion is connected to the other end of the extension portion through the third curved portion and the fourth curved portion, and the local structure is located between the second holding portion and the third curved portion, encompassing the fourth curved portion.
